(19) United States
(12) Patent Application Publication
(10) Pub. No.: US 2018/0322034 A1
(43) Pub. Date: Nov. 8, 2018

(54) RUNNING TEST SCRIPTS IN MULTIPLE LANGUAGE PLATFORMS

(71) Applicant: Microsoft Technology Licensing, LLC, Redmond, WA (US)

(72) Inventors: Lei KOU, Redmond, WA (US); Zhongyuan LI, Redmond, WA (US); Tianzhuang DOU, Redmond, WA (US)

(21) Appl. No.: 15/588,036

(22) Filed: May 5, 2017

(51) Int. Cl. G06F 11/36

(52) U.S. Cl. CPC G06F 11/3684; G06F 11/3688

(57) ABSTRACT

Testing is provided for software applications in each of a plurality of languages without a separate automation test script (TAS) for each language. A TAS runs on multiple language platforms without any change to the TAS. A method of running a test script in multiple language platforms comprises receiving a TAS for an application in a first language, retrieving language metadata used by the TAS, replacing the language metadata in the TAS with a language neutral identifier (LNI), retrieving data associated with a second language based on the LNI and providing the data associated with the second language to the TAS.

### BACKGROUND

A software application may be available in several languages such as English, Chinese, Japanese, French, etc. Testing software applications has become increasingly complex because many applications now run on several different platforms with different configurations, and in different languages. It is often desirable to test a software application in each language in which it is available.

Test scripts, such as regression test scripts, are typically used to test the quality of the software application. Thus, during the software development cycle and the product release cycle, each program is tested on each language platform, using automation test scripts (TASs) for quality control and to prevent regression. Testing is performed to ensure that any addition or modification to the software application does not break the existing or desired functionality of the application. When a change is made to the software, an automated test is an efficient way to perform testing (such as regression testing) to assure that no new defects were added. Usually, a different test script is recorded and used for each feature of the application that is being tested.

Many test scripts are designed to be run by a test automation engine (TAE) in one language platform. However, they have to be rewritten to run another language platform. More particularly, because of the different labels and objects for versions of a software application used in different languages, conventionally a different test script is recorded for each language. Thus, conventionally, each TAS can only run and test the target program in one language. As a result, a test script for testing a particular feature in one language needs to be rerecorded for testing the same feature in a different language. So conventionally, each TAS is modified for each language and then the program is tested with the TAS for each language using the appropriate modified TAS for that language. This technique is time-consuming, expensive, and cannot scale.

For example, in automated Graphical User Interface (GUI) testing of software applications for multiple languages, testing is done multiple times, at least one time for each of the several languages. Each test in a specific language is performed with a test script in that language's words. Test scripts are time consuming, complex, and expensive for a software developer or tester (i.e., a scriptwriter) to create. Maintaining a large number of test scripts, for every language of an application, is also time consuming and error-prone.

### SUMMARY

Testing is provided for software applications in each of a plurality of languages without a separate automation test script (TAS) for each language. A TAS runs on multiple language platforms without any change to the TAS.

In an implementation, a method of running a test script in multiple language platforms is provided. The method comprises: receiving an automation test script (TAS) for an application in a first language; retrieving language metadata used by the TAS; replacing the language metadata in the TAS with a language neutral identifier (LNI); retrieving data associated with a second language based on the LNI; and providing the data associated with the second language to the TAS.

In an implementation, a system of running a test script in multiple language platforms is provided. The system comprises: a client device comprising an application to be tested with an automation test script (TAS); a language resource provider plugin (LRPP) configurable to retrieve language metadata used by the TAS and replace the language metadata in the TAS with a language neutral identifier (LNI); a test automation engine (TAE) configurable to run the TAS on the application in a first language and in a second language; and a TAS library comprising the TAS.

In an implementation, a method of running a test script in multiple language platforms is provided. The method comprises: receiving a trigger to initiate a test on an application, in a first language, using an automation test script (TAS); recording the access path to language specific data associated with the TAS; formalizing the access path to a language neutral identifier (LNI); and writing the LNI to the TAS.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for testing a software application in each of a plurality of languages without a separate automation test script (TAS) for each language;

FIG. 2 is an illustration of an implementation of an exemplary language resource provider plugin (LRPP);

FIG. 3 is an operational flow of an implementation of a method for testing a software application in each of a plurality of languages without a separate TAS for each language;

FIG. 4 is an operational flow of an implementation of a method for capturing language metadata for use with testing a software application in each of a plurality of languages without a separate TAS for each language;

FIG. 5 is an operational flow of an implementation of a method for retrieving language specific data in a different platform for use with testing a software application in each of a plurality of languages without a separate TAS for each language; and

FIG. 6 shows an exemplary computing environment in which example embodiments and aspects may be implemented.

### DETAILED DESCRIPTION

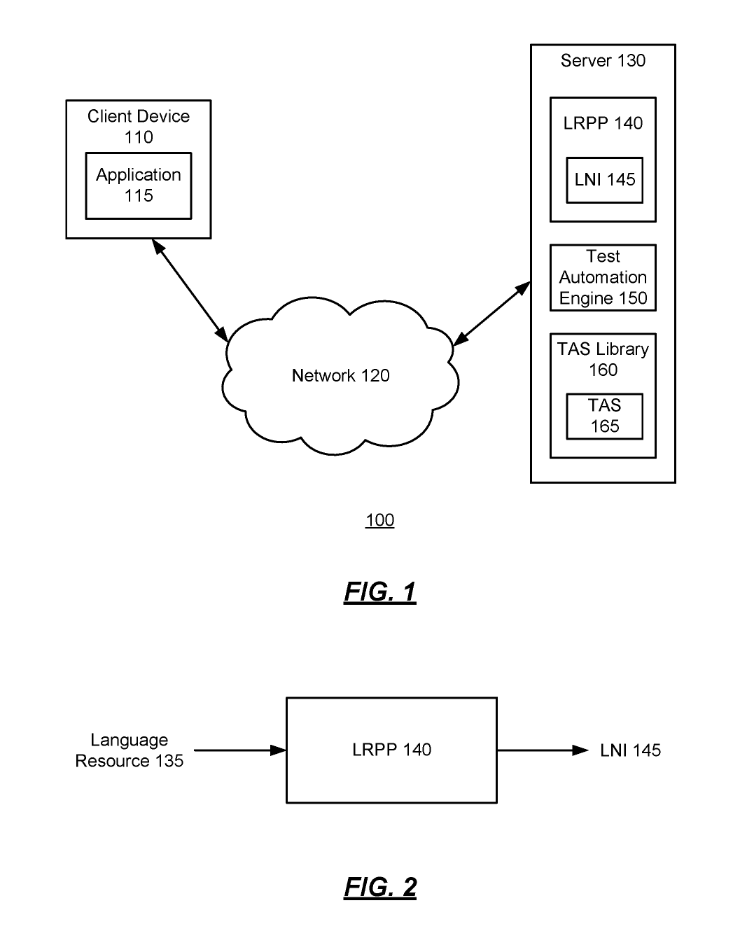

FIG. 1 is an illustration of an exemplary environment 100 for testing a software application in each of a plurality of languages without a separate automation test script (TAS) for each language. The environment 100 may include a client device 110 and a server 130 in communication through a network 120. The network 120 may be a variety of network types including the public switched telephone network (PSTN), a cellular telephone network, and a packet switched network (e.g., the Internet). Although only one client device 110 and one server 130 are shown in FIG. 1, there is no limit to the number of client devices and servers that may be supported.

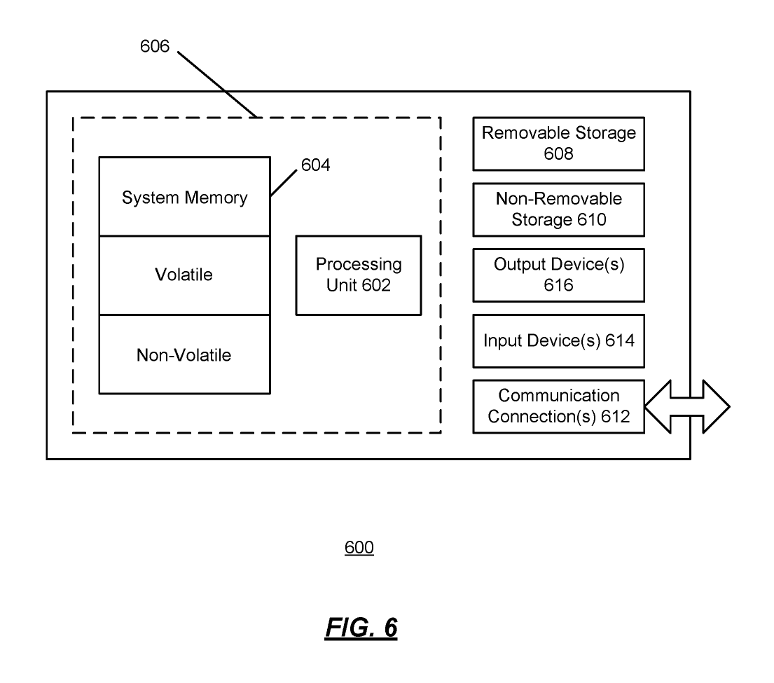

The client device 110 and the server 130 may be implemented using a variety of computing devices such as smart phones, desktop computers, laptop computers, and tablets. Other types of computing devices may be supported. A suitable computing device is illustrated in FIG. 6 as the computing device 600.

The client device 110 may include an application 115. The application 115 may be any type of software application, program, or product that is available in multiple languages, such as English, Chinese, Japanese, French, etc. The application 115 is to be tested in each language in which it is available, using a TAS as described further herein.

In an implementation, the application 115 is resident on the client device 110, and a test automation engine (TAE) 150 is resident on the server 130. The application 115 is a software application that is subject to quality assurance testing as performed by the TAE 150. In some implementations, the application 115 may be resident on a device that is remote from the client device 110, but otherwise accessible by the client device 110, such as through a network such as the network 120.

In an implementation, the TAE 150 is accessed from the client 110 over the network 120. A TAS 165, such as a regression test script defining at least one regression test, is run on the application 115 through the TAE 150. The TAE 150 may comprise a driver for running a TAS such as the TAS 165. The driver interacts with and executes the application 115. The TAS 165 may be obtained by the TAE 150 via a call to a TAS library 160.

The server 130 may include a language resource provider plugin (LRPP) 140, the TAE 150, and the TAS library 160. FIG. 2 is an illustration of an implementation of an exemplary LRPP, such as the LRPP 140. The LRPP 140 generates a language neutral identifier (LNI) 145 for a language resource 135 (e.g., a string or other resource(s)), in response to receiving the language resource 135 from a TAS 165 for a particular (e.g., first) language. Then, when the TAS 165 is to be used with another (e.g., second) language, the LNI 145 is converted, changed, or otherwise adjusted to (or used to access) the string or other resource(s) for the second language.

In some implementations, the string is an attribute, such as a name or label, or an object, such as a window or button of a screen or form, involved in a test script using a GUI map. In other implementations, the string is a variable within the physical description of an object, such as a window or button, involved in a test script without using a GUI map. In some implementations, objects such as windows or buttons involved in a test are represented by names which identify objects in the application 115. In an implementation, resources may comprise translations of user readable text strings.

In an implementation, the LNI is represented in a form such as TYPE\{ID|(Key, Value)}. In this manner, for example, the string “Start Menu” maps to RC\1024. The LNIs may be stored in one or more data tables associated with the plurality of languages. Each data table may comprise the LNIs for executing a TAS in a particular language. For example, prior to execution of a TAS, the execution language is identified and the appropriate LNI is retrieved from the corresponding data table, and converted to the string or resource(s) for use in that particular language in execution of the TAS.

The LRPP 140 is transparent to the user and can provide the localized data for the TAS 165 when the TAS 165 is run in a different language platform. The LRPP 140 does not change the TAS 165 semantic, and thus the TAS 165 remains unchanged.

Returning to FIG. 1, the TAE 150 receives and executes the TAS 165 using the LNI 145 for the language that the TAS 165 is to test the application 115. The output of the TAE 150 is provided to the client device 110, indicating the results of the test that was executed using the TAS 165. The TAE 150 is operable to run test scripts on the application 115 for testing the quality of the application 115. The TAE 150 may access and/or use strings and/or resource(s) during testing in accordance with the runtime language of the application 115.

Depending on the implementation, the TAE 150, the TAS library 160, and the TAS 165, along with the application 115 to be tested, can reside on the same computer system or on one or more separate computer systems. The various aspects and features described herein may be implemented on any numbers of client devices and servers, depending on the implementation.

The TAS library 160 comprises a plurality of automation test scripts, including TAS 165. The TAS library 160 provides the appropriate TAS to the TAE 150 during a test of an application such as the application 115. The TAS library 160 resident on the server 130 comprises test scripts such as regression test scripts. It should be appreciated that the TAS library 160 may reside within a different server, client, or other computing device connected to the network 120.

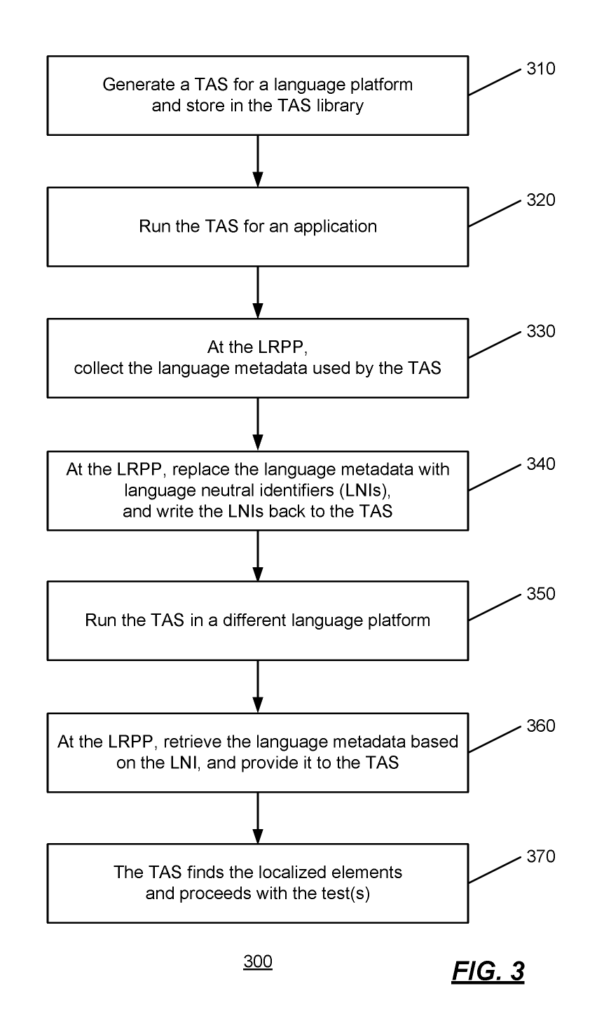

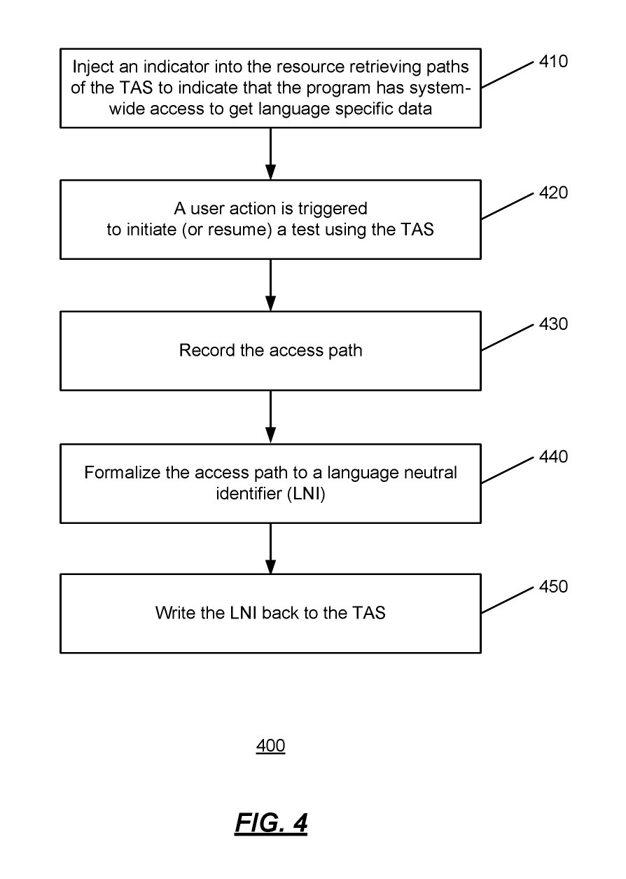

FIG. 3 is an operational flow of an implementation of a method 300 for testing a software application, such as the application 115, in each of a plurality of languages without a separate TAS, such as the TAS 165, for each language.

At 310, a TAS for a language platform, such as English, is generated or received by a user and stored or maintained in a TAS library, such as the TAS library 160, e.g. as the TAS 165. Any language of the plurality of languages that is supported by the software application can be used for the language platform at 310.

At 320, the TAS 165 is run for the application 115 in the language platform (i.e., a first language). When the TAS 165 runs, it requests strings and/or resources which contain language metadata.

At 330, a LRPP, such as the LRPP 140, collects the language metadata used by the strings and/or resources of the TAS 165. At 340, the LRPP 140 replaces the language specific data (i.e., the language metadata) with language neutral identifiers (LNIs), and writes the LNIs back to the TAS 165. In this manner, in an implementation, the LRPP 140 captures the “asks” and the resources that the operating system (OS) requests, and generates a LNI for each of those resources. After generating the LNIs, the LRPP 140 writes the LNIs back to the TAS 165.

At some point, at 350, the TAS 165 is run in a different language platform, such as a language other than English (i.e., a second language). At 360, the LRPP 140 retrieves the language specific data (i.e., language metadata) for the TAS 165 and the language being used (i.e., the second language) based on the LNI, and provides this language specific data (the language metadata) to the TAS 165. In this manner, in an implementation, the LRPP 140 obtains the LNI and converts it to the appropriate resource (i.e., the associated resource) and requests that the OS gets that resource.

At 370, the TAS 165 obtains the localized elements (e.g., the resource(s) and/or strings, based on the language metadata) and proceeds with the associated test(s) of the application 115 in the second language. In this manner, the application 115 under test uses the correct language of user readable text during testing, in an implementation.

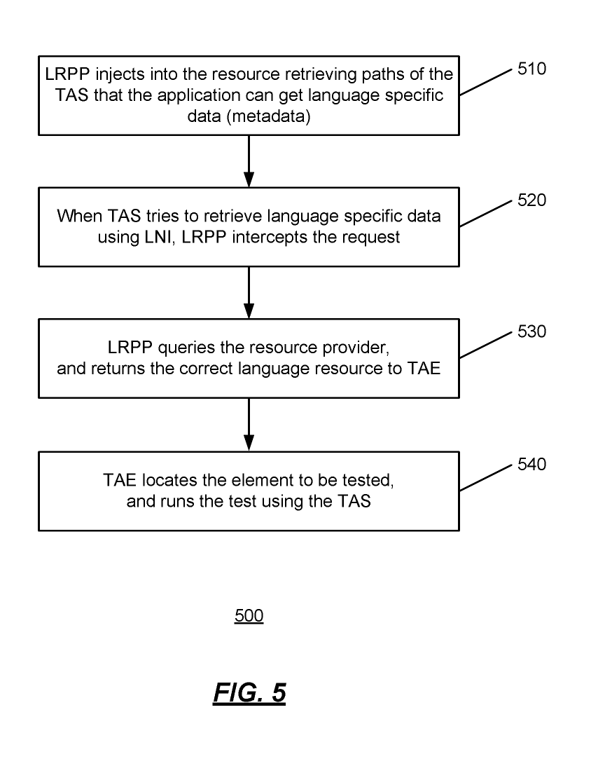

FIG. 4 is an operational flow of an implementation of a method 400 for capturing language metadata for use with testing a software application, such as the application 115, in each of a plurality of languages without a separate TAS, such as the TAS 165, for each language.

At 410, an LRPP, such as the LRPP 140, injects an indicator into the resource retrieving paths of the TAS 165 to indicate that the application 115 has system-wide access to get language specific data (i.e., metadata), such as a resource file, a configuration file, a multilingual user interface (MUI) file, etc.

At 420, a user action is triggered to initiate (or resume) a test using the TAS 165. At 430, in response to the triggering of the user action, the LRPP 140 records the access path to the language specific data. At 440, the LRPP 140 formalizes the access path to a LNI. At 450, the LNI is written back to the TAS 165.

FIG. 5 is an operational flow of an implementation of a method 500 for retrieving language specific data in a different platform for use with testing a software application, such as the application 115, in each of a plurality of languages without a separate TAS, such as the TAS 165, for each language.

At 510, an LRPP, such as the LRPP 140, injects into the resource retrieving paths of the TAS 165 that the application 115 can get language specific data (i.e., metadata), such as a resource file, a configuration file, a multilingual user interface (MUI) file, etc.

At 520, when the TAS 165 is run and tries to retrieve language specific data using an LNI, the LRPP 140 intercepts the request. At 530, the LRPP 140 queries the resource provider in the current system (e.g., the current OS), and returns the correct language resource to the TAE, such as the TAE 150. At 540, the TAE 540 locates the element to be tested (such as a GUI element), and runs the test using the TAS 165.

FIG. 6 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a method of running a test script in multiple language platforms is provided. The method comprises: receiving a TAS for an application in a first language; retrieving language metadata used by the TAS; replacing the language metadata in the TAS with a LNI; retrieving data associated with a second language based on the LNI; and providing the data associated with the second language to the TAS.

Implementations may include some or all of the following features. The method may further comprise generating the TAS for the first language and storing the TAS in a TAS library. The method may further comprise running the TAS for the application in the first language, wherein retrieving the language metadata may be performed in response to the TAS running for the application in the first language. Replacing the language metadata in the TAS may comprise writing the LNI to the TAS. The method may further comprise running the TAS in the second language prior to retrieving the data associated with the second language based on the LNI. Retrieving the data associated with the second language based on the LNI may comprise retrieving language metadata for the TAS for the second language using the LNI. The method may further comprise running the TAS for the application in the second language, using the data associated with the second language provided to the TAS. Replacing the language metadata in the TAS with a LNI may comprise replacing the language metadata in the TAS with a plurality of LNIs, and retrieving the data associated with the second language based on the LNI may comprise retrieving the data based on the plurality of LNIs. Retrieving the language metadata used by the TAS may be performed using a LRPP, and retrieving the data associated with the second language based on the LNI may be performed using the LRPP. The LRPP, the LNI, and the TAS may reside on a same server, and the application may reside on a client device. The language metadata used by the TAS may comprise at least one language resource. The TAS may be a regression test script defining at least one regression test. The first language may be English and the second language may be a language other than English.

In an implementation, a system of running a test script in multiple language platforms is provided. The system comprises: a client device comprising an application to be tested with a TAS; a LRPP configurable to retrieve language metadata used by the TAS and replace the language metadata in the TAS with a LNI; a TAE configurable to run the TAS on the application in a first language and in a second language; and a TAS library comprising the TAS.

Implementations may include some or all of the following features. The system may further comprise a server in communication with the client device through a network, the server comprising the LRPP, the TAE, and the TAS library. The TAS may be generated for the first language, and the LRPP may be further configurable to retrieve data associated with the second language based on the LNI. The LRPP may be configured to retrieve the language metadata used by the TAS in response to the TAS running for the application in the first language.

In an implementation, a method of running a test script in multiple language platforms is provided. The method comprises: receiving a trigger to initiate a test on an application, in a first language, using a TAS; recording the access path to language specific data associated with the TAS; formalizing the access path to a LNI; and writing the LNI to the TAS.

Implementations may include some or all of the following features. The method may be comprise initiating the test on the application, in a second language, using the TAS; intercepting a request to retrieve the language specific data using the LNI, for the TAS; and returning a language resource for the second language to a TAE for running the test using the TAS. Intercepting and returning may be performed by a LRPP that is configurable to retrieve language specific data used by the TAS and replace the language specific data in the TAS with the LNI.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of running a test script in multiple language platforms, comprising:
receiving an automation test script (TAS) for an application in a first language;
retrieving language metadata used by the TAS;
replacing the language metadata in the TAS with a language neutral identifier (LNI);
retrieving data associated with a second language based on the LNI; and
providing the data associated with the second language to the TAS.

2. The method of claim 1, further comprising generating the TAS for the first language and storing the TAS in a TAS library.

3. The method of claim 1, further comprising running the TAS for the application in the first language, wherein retrieving the language metadata is performed in response to the TAS running for the application in the first language.

4. The method of claim 1, wherein replacing the language metadata in the TAS comprises writing the LNI to the TAS.

5. The method of claim 1, further comprising running the TAS in the second language prior to retrieving the data associated with the second language based on the LNI.

6. The method of claim 1, wherein retrieving the data associated with the second language based on the LNI comprises retrieving language metadata for the TAS for the second language using the LNI.

7. The method of claim 1, further comprising running the TAS for the application in the second language, using the data associated with the second language provided to the TAS.

8. The method of claim 1, wherein replacing the language metadata in the TAS with a LNI comprises replacing the language metadata in the TAS with a plurality of LNIs, and wherein retrieving the data associated with the second language based on the LNI comprises retrieving the data based on the plurality of LNIs.

9. The method of claim 1, wherein retrieving the language metadata used by the TAS is performed using a language resource provider plugin (LRPP), and retrieving the data associated with the second language based on the LNI is performed using the LRPP.

10. The method of claim 9, wherein the LRPP, the LNI, and the TAS reside on a same server, and wherein the application resides on a client device.

11. The method of claim 1, wherein the language metadata used by the TAS comprises at least one language resource.

12. The method of claim 1, wherein the TAS is a regression test script defining at least one regression test.

13. The method of claim 1, wherein the first language is English and the second language is a language other than English.

14. A system of running a test script in multiple language platforms, comprising:
a client device comprising an application to be tested with an automation test script (TAS);
a language resource provider plugin (LRPP) configurable to retrieve language metadata used by the TAS and replace the language metadata in the TAS with a language neutral identifier (LNI);
a test automation engine (TAE) configurable to run the TAS on the application in a first language and in a second language; and
a TAS library comprising the TAS.

15. The system of claim 14, further comprising a server in communication with the client device through a network, the server comprising the LRPP, the TAE, and the TAS library.

16. The system of claim 14, wherein the TAS is generated for the first language, and wherein the LRPP is further configurable to retrieve data associated with the second language based on the LNI.

17. The system of claim 14, wherein the LRPP is configured to retrieve the language metadata used by the TAS in response to the TAS running for the application in the first language.

18. A method of running a test script in multiple language platforms, comprising:
receiving a trigger to initiate a test on an application, in a first language, using an automation test script (TAS);
recording the access path to language specific data associated with the TAS;
formalizing the access path to a language neutral identifier (LNI); and
writing the LNI to the TAS.

19. The method of claim 18, further comprising:
initiating the test on the application, in a second language, using the TAS;
intercepting a request to retrieve the language specific data using the LNI, for the TAS; and
returning a language resource for the second language to a test automation engine (TAE) for running the test using the TAS.

20. The method of claim 19, wherein the intercepting and returning is performed by a language resource provider plugin (LRPP) that is configurable to retrieve language specific data used by the TAS and replace the language specific data in the TAS with the LNI.
